(19) United States
(12) Patent Application Publication
(10) Pub. No.: US 2013/0026983 A1
(43) Pub. Date: Jan. 31, 2013

(54) BATTERY PACK

(71) Applicants: Hiroyoshi YAMAMOTO, Sumoto-shi (JP); Mikitaka TAMAI, Sumoto-shi (JP)

(72) Inventors: Hiroyoshi YAMAMOTO, Sumoto-shi (JP); Mikitaka TAMAI, Sumoto-shi (JP)

(21) Appl. No.: 13/558,612

(22) Filed: Jul. 26, 2012

(30) Foreign Application Priority Data
Jul. 28, 2011 (JP) 2011-166094

(51) Int. Cl. H02J 7/00

(52) U.S. Cl. 320/108

(57) ABSTRACT

The battery pack includes a rechargeable battery cell, an energized coil, a temperature detector, a switch, a controller, power supply terminals, and a temperature terminal. The coil can be electromagnetically connected to an energizing coil of a charger. The detector detects the cell temperature. The switch is serially connected to the detector. The controller controls ON/OFF of the switch. The pack can be electrically connected through the terminals to a battery-driven device. The cell can be charged/discharged through the power supply terminals. The temperature terminal is connected to the detector. The controller is connected to the temperature terminal. When the pack is charged by the charger in the non-contact charging manner, the switch is turned OFF so that the pack can communicate with the device through the temperature terminal.

### BACKGROUND OF THE INVENTION

1. Field of the Invention

The present invention relates to a battery pack that includes an energized coil of the battery pack to be placed on a charging base and electromagnetically connected to an energizing coil of the charging base for transmitting electric power to the energized coil from the energizing coil by using electromagnetic induction whereby charging a battery mounted to the battery pack.

2. Description of the Related Art

Battery-driven devices (typically, mobile devices such as mobile phone and portable music player) are often driven by rechargeable batteries for convenience in portability. This type of battery-driven device includes a base battery or battery pack as battery for driving the device. When contacts of the battery-driven device are connected to a charger, the battery that is mounted to the battery-driven device can be charged through the contacts by the charger. Contrary to this, not by the contact connection but by using electromagnetic induction, a charging base has been developed which transmits electric power from an energizing coil included in the charging base to an energized coil when the battery is charged (see Japanese Patent Laid-Open Publication No. JP 2008-141,940 A).

On the other hand, the battery-driven device, which is driven by the battery pack, has an indicator window through which the status, the remaining capacity of the battery, or the like is indicated. The status includes under-charge status, full charge status, for example. The under-charge status indicates that the battery pack is charged (under charging operation). The full charge status indicates that the battery pack is fully charged. In order to indicate the status, the remaining capacity, or the like, as shown in FIG. 9, it is necessary to additionally provide communication terminals for connection between the battery-driven device and the battery pack. However, if the communication terminals are additionally provided, the cost of the battery-driven device and the battery pack will be increased. In addition to this, the space is limited which accommodates the communication terminals, and components for communication between the battery-driven device and the battery pack. Particularly, since, in recent years, battery packs are required for downsizing in size or thickness, it is hard to satisfy both the cost saving, and this downsizing requirement.

In order to satisfy cost saving and downsizing requirements, Assignee has been developed an electronic-device battery pack including terminals that serve as both communication terminals and temperature terminals (Japanese Patent Laid-Open Publication No. JP 2007-26,712 A). As shown in FIG. 10, this battery pack includes a temperature-sensing element that is connected to a communication line in the battery pack, a switching device that connects/disconnects the temperature-sensing element to/from a reference voltage line, and a controller of communication through the communication line and the switching device. The controller turns the switching device ON to activate the communication line, and turns the switching device OFF to deactivate the communication line. Accordingly, in the case where the communication line is inactive, a voltage on the temperature-sensing element can be provided to the electronic-device side through the communication line. Thus, the voltage on the temperature-sensing element can be detected through the communication line by the electronic device. On the other hand, in the case where the communication line is active, the communication line is not affected by the voltage variation of the temperature-sensing element. Accordingly, the communication line can be used.

However, this battery pack is constructed to be connected only to one electronic device, and cannot be charged by other method other than this electronic device. For this reason, if this battery pack is charged by other method other than this electronic device, in other words, by a non-contact charging method, there is a problem that this battery pack cannot properly operate in charging operation, communication, battery temperature detection, and full charge status indication.

In particular, a battery pack that has a non-contact charging function often additionally has the conventional charging function through electronic devices. In this case, it is conceivable that a plurality of charging methods will conflict with each other in the charging operation on this battery. If charging methods conflict with each other, the known battery pack may not be sufficiently prepared for selecting which charging method charges this battery pack, or for selecting which charging method stops charging this battery pack. Also, the known battery pack may not be sufficiently prepared for communication if charging methods conflict with each other.

The present invention is aimed at solving the problem. It is a main object of the present invention to provide a battery pack that can be charged by a non-contact charging method, and can transmit/receive required information to/from a non-contact charger without additional communication terminals.

### SUMMARY OF THE INVENTION

To achieve the above object, a battery pack according to a first aspect of the present invention is a battery pack that can be connected to a battery-driven device, and supply this battery-driven device with electric power for driving this battery-driven device 100. Also, the battery pack can be placed on a charging base, and supplied with electric power from an energizing coil included in this charging base for charging this battery pack in a non-contact charging manner. The battery pack includes a rechargeable battery cell, an energized coil, a temperature-detecting portion, a terminal-switching portion, a pack-controlling portion, and connection terminals. The energized coil can be electromagnetically connected to the energizing coil that is included in the charging base. The temperature-detecting portion detects the temperature of the rechargeable battery cell. The terminal-switching portion is connected to the temperature-detecting portion in series. The pack-controlling portion controls ON/OFF of the terminal-switching portion. The battery pack can be electrically connected through the connection terminals to the battery-driven device. The connection terminals include a pair of power supply terminals and, and a temperature terminal. The rechargeable battery cell can be charged/discharged through the power supply terminals and. The temperature terminal is connected to the temperature-detecting portion. The pack-controlling portion is connected to the temperature terminal. When the battery pack is charged by the charging base in the non-contact charging manner, the terminal-switching portion is turned OFF so that the battery pack can communicate with the battery-driven device through the temperature terminal. According to this construction, the temperature terminal can serve as a communication terminal through which the battery pack can communicate with the battery-driven device when the battery pack is charged in a non-contact charging manner. Thus, one terminal can serve as both the temperature terminal and the communication terminal. Since a communication terminal is not separately required, it is possible to suppress the increase of the battery pack in cost. In addition, it is possible to avoid that the space is limited by the increased number of components.

In a battery pack according to a second aspect of the present invention, the battery pack can be charged by an AC/DC adapter with the battery pack being connected to the battery-driven device. The pack-controlling portion can turn the terminal-switching portion ON when the battery pack is charged by the AC/DC adapter so that information about the temperature of the rechargeable battery cell can be provided to the battery-driven device. According to this construction, the rechargeable battery cell temperature can be transmitted through the temperature terminal when the battery pack is charged by the AC/DC adapter.

In a battery pack according to a third aspect of the present invention, the terminal-switching portion can include an FET. The pack-controlling portion can include a terminal-switching control line SWL through which the ON/OFF signal is provided to the gate terminal of the FET. The pack-controlling portion can turn the terminal switching control line SWL to HIGH when the battery pack is charged in the non-contact charging manner. The pack-controlling portion can turn the terminal switching control line SWL to LOW when the battery pack is charged by the AC/DC adapter. Thus, the temperature-detecting portion can be connected/disconnected to/from the temperature terminal. According to this construction, the pack-controlling portion can easily switch between the functions of the temperature terminal.

In a battery pack according to a fourth aspect of the present invention, the temperature-detecting portion can be connected to a first switching element. The control terminal of the first switching element can be connected to a second switching element. ON/OFF of the first switching element can be controlled based on ON/OFF of the second switching element. When the second switching element is brought OFF, the voltage from the AC/DC adapter can be applied to the control terminal of the first switching element so that the first switching element can be turned ON.

In a battery pack according to a fifth aspect of the present invention, the FETs of the terminal-switching portion can include first and second FETs. The first FET has the gate terminal, which is connected to the terminal-switching control line SWL. The second FET has the gate terminal, which is connected to the drain terminal of the first FET. The source terminals of the first and second FETs can be connected to a common line. When the battery pack is charged by the AC/DC adapter, the pack-controlling portion can turn the terminal-switching control line SWL to LOW so that the first FET can be turned OFF, and can apply the voltage from the AC/DC adapter to the gate terminal of the second FET and turn this second FET ON so that current can flow through the temperature-detecting portion.

In a battery pack according to a sixth aspect of the present invention, when the battery pack is charged by the charging base in the non-contact charging manner, the battery-driven device can detect through a device-side temperature terminal, which is included in the battery-driven device and is connected to the temperature terminal of the battery pack, that the pack-controlling portion turns the terminal-switching portion OFF so that the battery pack can communicate with the battery-driven device. According to this construction, when the battery pack is charged in the non-contact charging manner, the battery pack can inform the battery-driven device that the charging mode is switched to the non-contact charging mode so that the battery pack can communicate with the battery-driven device.

In a battery pack according to a seventh aspect of the present invention, when the battery pack is charged by the charging base in the non-contact charging manner, the device-side temperature terminal, which is included in the battery-driven device and is connected to the temperature terminal of the battery pack, can be connected to a pull-up resistor so that the pack-controlling portion can communicate with a device-side control portion. According to this construction, the battery pack can communicate with the battery-driven device through the temperature terminal and the device side temperature terminal.

In a battery pack according to an eighth aspect of the present invention, if the charging operation of the AC/DC adapter conflicts with the non-contact charging operation of the charging base, the pack-controlling portion can inform the battery-driven device that the non-contact charging operation stops, and can request the battery-driven device to charge the battery pack by using the AC/DC adapter based on the communication through the temperature terminal. According to this construction, if the charging operation of the AC/DC adapter conflicts with the non-contact charging operation of the charging base, the non-contact charging operation stops so that the charging operation of the AC/DC adapter has higher priority than the non-contact charging operation of the charging base. As a result, the battery pack can be stably charged.

In a battery pack according to a ninth aspect of the present invention, the temperature-detecting portion can be a thermistor that is arranged in proximity to the rechargeable battery cell. According to this construction, an electric signal indicating the rechargeable battery cell temperature can be outputted by the thermistor.

In a battery pack according to a tenth aspect of the present invention, the energized coil can have a rectangular exterior shape. According to this construction, the winding length of the energized coil can be large. Correspondingly, the inductance of the energized coil can be increased. In addition, as compared with a circular coil, since the orientation of the rectangular coil can be restricted, the rectangular coil can be easily held in a predetermined orientation.

In a battery pack according to an eleventh aspect of the present invention, a device-connection determining portion can be further provided which determines whether the battery pack is connected to the battery-driven device or not.

In a battery pack according to a twelfth aspect of the present invention, when the pack-controlling portion tries communicating with the battery-driven device, the device-connection determining portion can determine whether the battery pack is connected to the battery-driven device or not based on whether the pack-controlling portion successfully communicates with the battery-driven device or not.

In a battery pack according to a thirteenth aspect of the present invention, the pack-controlling portion can determine that the battery pack is disconnected from the battery-driven device if the pack-controlling portion cannot communicate with the battery-driven device through the temperature terminal. If the pack-controlling portion determines that the battery pack is disconnected from the battery-driven device, the pack-controlling portion can control charging operation on the battery pack in the non-contact charging manner according to the specifications of this battery pack.

In a battery pack according to a fourteenth aspect of the present invention, the pack-controlling portion can determine that the battery pack is connected to the battery-driven device if the pack-controlling portion successfully communicates with the battery-driven device through the temperature terminal. If the pack-controlling portion determines that the battery pack is connected to the battery-driven device, the pack-controlling portion can control charging operation on the battery pack according to the connection conditions of this battery pack to the battery-driven device.

The above and further objects of the present invention as well as the features thereof will become more apparent from the following detailed description to be made in conjunction with the accompanying drawings.

### BRIEF DESCRIPTION OF THE DRAWINGS

FIG. 1 is a perspective view showing a non-contact charging base and a battery-driven device including a battery pack when the battery-driven device is placed on the charging base;

FIG. 2 is a vertical cross-sectional view showing the charging base shown in FIG. 1 and the battery-driven device with the battery-driven device being placed on the charging base;

FIG. 3 is a vertical cross-sectional view showing the charging base shown in FIG. 1 and the battery pack with the battery pack being solely placed on the charging base;

FIG. 4 is a block diagram showing the electric circuit of the charging base shown in FIG. 1, and the battery-driven device;

FIG. 5 is a block diagram showing the electric circuit of the charging base and the battery pack shown in FIG. 3;

FIG. 6 is a block diagram showing the electric circuit of the battery-driven device shown in FIG. 1, and an AC/DC adaptor with the battery-driven device being connected to the AC/DC adaptor;

FIG. 7 is a circuit diagram showing the charging base, the battery-driven device and the AC/DC adapter with the battery-driven device being connected to the AC/DC adapter and placed on the charging base;

FIG. 8 is a flowchart showing the selection procedure when the charging operation of the AC/DC adapter conflicts with the non-contact charging operation of the charging base;

FIG. 9 is a block diagram showing a battery-driven device and a battery pack that have communication terminals for connection between the battery-driven device and the battery pack; and

FIG. 10 is a circuit diagram showing a known charger.

### DETAILED DESCRIPTION OF THE EMBODIMENT(S)

The following description will describe embodiments according to the present invention with reference to the drawings. It should be appreciated, however, that the embodiments described below are illustrations of a battery pack used therein to give a concrete form to technical ideas of the invention, and a battery pack of the invention is not specifically limited to description below. Furthermore, it should be appreciated that the members shown in claims attached hereto are not specifically limited to members in the embodiments. Unless otherwise specified, any dimensions, materials, shapes and relative arrangements of the members described in the embodiments are given as an example and not as a limitation. Additionally, the sizes and the positional relationships of the members in each of drawings are occasionally shown larger exaggeratingly for ease of explanation. Members same as or similar to those of this invention are attached with the same designation and the same reference signs, and their description is omitted. In addition, a plurality of structural elements of the present invention may be configured as a single part that serves the purpose of a plurality of elements, on the other hand, a single structural element may be configured as a plurality of parts that serve the purpose of a single element. Also, the description of some of examples or embodiments may be applied to other examples, embodiments or the like.

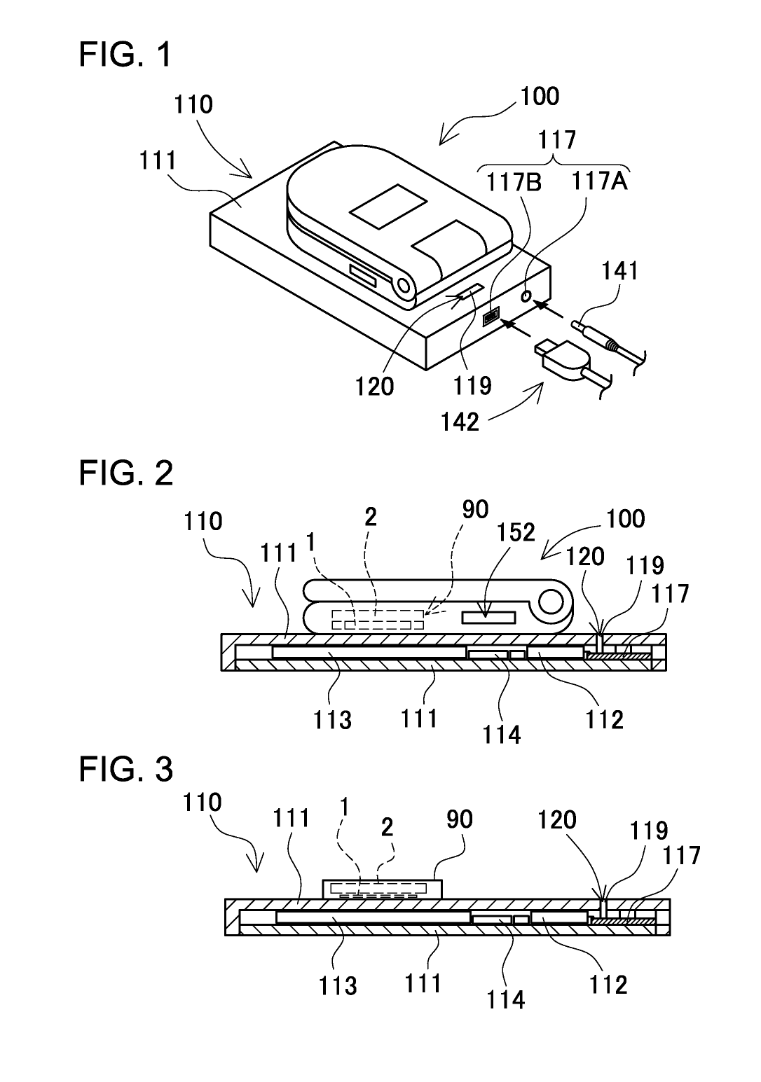

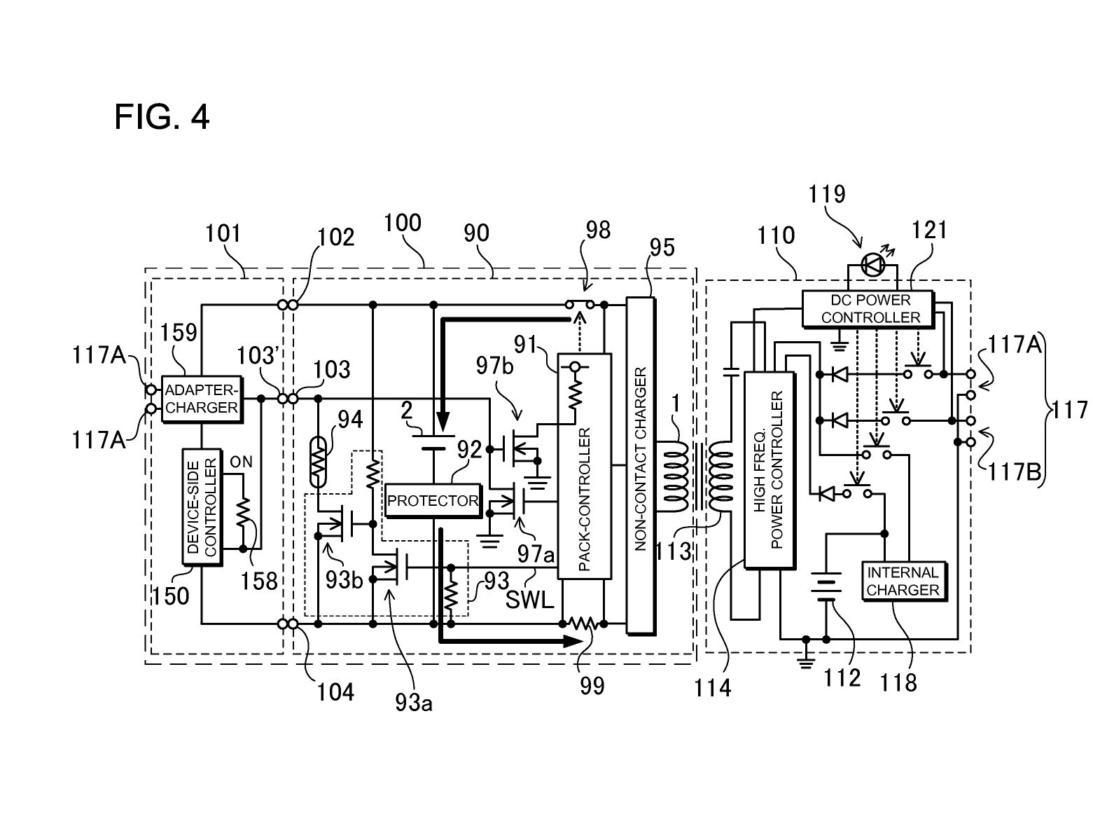

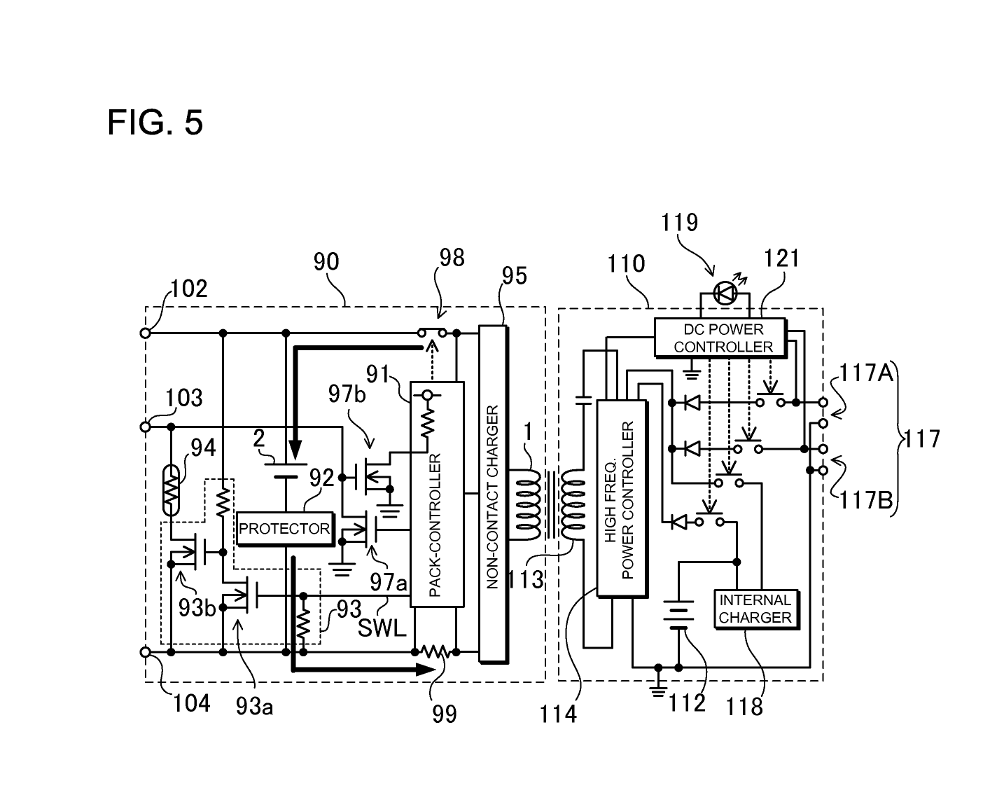

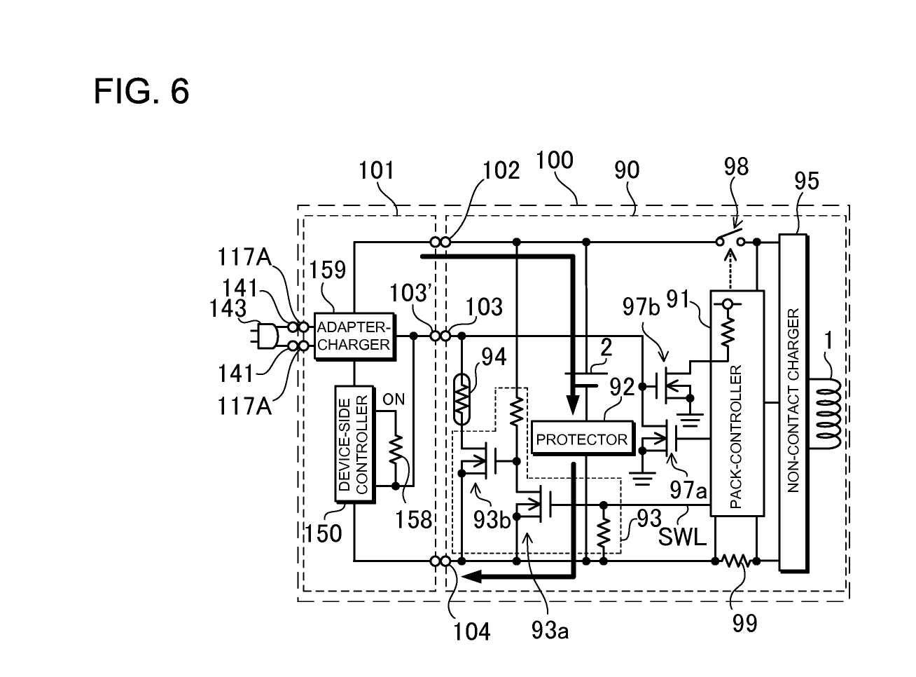

With reference to FIGS. 1 to 6, the following description will describe a battery pack according to an embodiment of the present invention, which is adopted to a battery pack of a mobile phone. FIG. 1 is a perspective view showing a non-contact charging base 110 and a battery-driven device 100 including a battery pack when the battery-driven device 100 is placed on the charging base 110. FIG. 2 is a vertical cross-sectional view showing the battery-driven device and the charging base shown in FIG. 1. FIG. 3 is a vertical cross-sectional view showing the charging base 110 and a battery pack 90 with the battery pack 90 being solely placed on the charging base 110. FIG. 4 is a block diagram showing the electric circuit of the charging base 110 and the battery-driven device 100 with the battery-driven device 100 being placed on the charging base 110 for charging a rechargeable battery cell 2 of the battery pack 90. FIG. 5 is a block diagram showing the electric circuit of the charging base 110 and the battery pack 90 with the battery pack 90 being solely placed on the charging base 110 for charging a rechargeable battery cell 2. FIG. 6 is a block diagram showing the electric circuit of the battery-driven device 100 with the battery-driven device being supplied with DC power through DC connection terminals 117A of the battery-driven device 100 for charging the rechargeable battery cell 2 of the battery pack mounted to the battery-driven device 100 in a wire-connecting manner. The illustrated battery pack 100 can be connected to the battery-driven device 100, and supply this battery-driven device 100 with electric power for driving this battery-driven device 100. Also, the battery pack 100 can be placed on the charging base 110, and supplied with electric power from an energizing coil 113 included in this charging base 110 for charging this battery pack in a non-contact charging manner. In FIG. 4, the battery-driven device 100 with the battery pack 90 mounted to this battery-driven device 100 is placed on the charging base 110 so that the battery pack 90 shown in the center part of FIG. 4 can be charged. Also, the battery pack 90 can be charged by the battery-driven device 100 with the battery-driven device 100 being connected to an AC/DC adapter 143. That is, the AC/DC adapter 143 can be connected to the battery-driven device 100 shown in the left part of FIG. 5 so that the battery pack 90 shown in the central part of FIG. 5 can be charged with the electric power supplied from the AC/DC adapter 143. Thus, the battery pack 90 can be charged both by the non-contact charging operation of the charging base 110 (shown in the right part of FIG. 4), and the adapter-charging operation of the battery-driven device 100 (shown in the left part of FIG. 5). In addition to the case where the battery pack 90 connected to the battery-driven device 100 is charged in the non-contact charging manner, the battery pack 90 can be charged in the non-contact charging manner with the battery pack 90 being disconnected (solely provided) from the battery-driven device 100 as shown in FIG. 3.

### (Charging Base 110)

The charging base 110 shown in FIGS. 1 to 3 includes the energizing coil 113, and a high frequency power supply control circuit 114. The energizing coil 113 can be electromagnetically connected to an energized coil 1 of the battery pack 90. The high frequency power supply control circuit 114 supplies high frequency electric power to this energizing coil 113. Driving electric power for this charging base 110 can be obtained by converting electric power supplied from external commercial power or the like, or from a charging-base-side rechargeable battery 112, which is included in the charging base 110 and can be charged by commercial power or the like. In the charging base according to this embodiment shown in FIG. 1, the electric power from the outside can be supplied through a DC connection plug 141 of a charging-base-side AC/DC converter (not shown), or through a USB cable 142. The charging base 110 includes DC input terminals 117 in an exterior case 111. The electric power from the outside can be supplied through the DC input terminals 117 to the charging base 110. In this embodiment, the DC input terminals 117 include a DC connection receptacle 117A, and a USB slot 117B. The DC connection plug 141 can be connected to the DC connection receptacle 117A. The USB cable 142 can be connected to the USB slot 117B. The charging-base-side rechargeable battery 112 can be charged with DC power through the direct-current input terminals 117. Also, the high frequency power supply control circuit 114 can be directly supplied with DC power through the direct-current input terminals 117. If electric power is not supplied to the charging base through the DC input terminals 117 from the external power supply, the charged charging-base-side rechargeable battery 112 can supply DC power to the high frequency power supply control circuit 114, or the like. According to this construction, the charging base 110 can be a mobile charger. Even if electric power is not supplied to the charging base 110 through the DC input terminals 117, the charging-base-side rechargeable battery 112 can supply DC power to the high frequency power supply control circuit 114 so that the high frequency electric power can be produced by the high frequency power supply control circuit 114.

### (Battery-Driven Device 100)

The battery pack 90 can be connected to the battery-driven device 100. The battery-driven device 100 can be driven with electric power that is supplied by this battery pack 90. The battery pack 90 can be accommodated in the battery-driven device 100. The battery-driven device 100 according to this embodiment shown in FIG. 1 is a mobile phone. After a back cover is removed from the battery-driven device 100 main unit, the battery pack 90 can be accommodated in a case of the battery-driven device 100. However, the battery pack is not necessarily accommodated in the battery-driven device main unit. The battery pack may be mounted to and exposed from the battery-driven device main unit. For example, in the case where the battery-driven device is a power tool or a video camera, the battery pack can be removably mounted to a part of the battery-driven device main unit. On the other hand, the battery pack may not be removably mounted to the battery-driven device but may be non-removably fixed to the battery-driven device.

Also, the battery-driven device 100 includes the DC connection terminals 117A as the input terminals through which the device side AC/DC adapter 143 can be connected to the AC power supply. According to this construction, in the case where the battery pack 90 is connected to the battery-driven device 100, the battery pack 90 can be supplied with DC power through the DC connection terminals 117A so that the rechargeable battery cell 2 in the battery pack 90 can be stably charged.

### (Battery Pack 90)

The battery pack 90 shown in FIG. 4 includes the rechargeable battery cell 2, the energized coil 1, a temperature-detecting portion 94, a terminal-switching portion 93, a pack-controlling portion 91, and connection terminals. The energized coil 1 can be electromagnetically connected to the energizing coil 113 that is included in the charging base 110. The temperature-detecting portion 94 detects the temperature of the rechargeable battery cell 2. The terminal-switching portion 93 is connected to the temperature-detecting portion 94 in series. The pack-controlling portion 91 controls ON/OFF of the terminal-switching portion 93. The battery pack can be electrically connected through the connection terminals to the battery-driven device 100. The connection terminals include a pair of power supply terminals 102 and 104, and a temperature terminal 103. The rechargeable battery cell 2 can be charged/discharged through the power supply terminals 102 and 104. The temperature terminal 103 is connected to the temperature-detecting portion 94.

As shown in the circuit diagram of FIG. 4, the battery pack 90 can be charged with the battery pack 90 being mounted to the battery-driven device 100. Also, the battery pack 90 can be charged with the battery pack 90 being disconnected from the battery-driven device 100 and solely placed on the charging base 110 as shown in the cross-sectional view of FIG. 3. In either case where the battery pack 90 is mounted to or disconnected from the battery-driven device 100, the energized coil 1 of the battery pack 90 can be electromagnetically connected to the transmitting coil 113 of the charging base 110 so that induced electric power is provided by the received magnetic flux.

Although the energized coil 1 can have a circular exterior shape, it is preferable that the energized coil 1 have a rectangular exterior shape. In the case where the energized coil 1 has a rectangular exterior shape, the winding length of the energized coil 1 can be large. Correspondingly, the inductance of the energized coil can be increased. In addition, as compared with a circular coil, since the orientation of the rectangular coil can be restricted, the rectangular coil can be easily held in a predetermined orientation.

The following description describes the operating principle of charging operation of the battery pack 90 on the rechargeable battery cell 2 with electric power received from the non-contact charging base 110 with reference to FIG. 4. When the energized coil 1 is electromagnetically connected to the energizing coil 113 of the charging base 110, induced electric power is produced in the energized coil 1, and then converted into DC power by the non-contact charging circuit 95 as shown in FIG. 4 so that the rechargeable battery cell 2 can be charged. Although not illustrated in this embodiment, the rechargeable battery cell 2 includes a monitoring circuit that monitors monitoring parameters such as charging voltage, current, and battery temperature. If the monitor circuit determines that any of the monitoring parameters exceeds thresholds that are previously set with reference to the rechargeable battery cell 2, the monitor circuit provides a modulation signal to the energized coil 1 so that the signal is transmitted to the energizing coil 113. The high frequency power supply control circuit 114 can adjust the output power based on the transmitted signal. For example, when the rechargeable battery cell 2 of the battery pack 90 becomes fully charged, the energizing coil can receive the signal from the battery pack 90 so that the high frequency power supply control circuit 114 of the charging base 110 can stop supplying the output power. According to this construction, the safety of the battery pack 90 can be maintained. In addition, since the charging base 110 can stop supplying the output power, it is possible to suppress the waste of electric power.

### (Rechargeable Battery Cell 2)

The rechargeable battery cell 2, which is included in the battery pack 90, has a rectangular parallelepiped the thickness of which is smaller than the width. The rechargeable battery cell 2 includes an exterior container having surfaces that are integrally formed with each other. The exterior container can be a metal case. For example, the metal case can be formed of aluminum, or the like. In this case, the metal case can protect the interior members against external shocks, and have good heat dissipation.

In the case where the rechargeable battery cell 2 according to this embodiment is a rechargeable lithium-ion battery or lithium-polymer battery, which has a large energy density, the battery pack can be light, thin, and small as a whole. Accordingly, the battery can be conveniently used for mobile battery-driven devices. However, the rechargeable battery cell is not limited to a rechargeable lithium-ion battery or lithium-polymer battery. Any rechargeable batteries can be used such as nickel metal hydride battery, and nickel-cadmium battery.

### (Non-Contact Charging Operation)

The following description describes the charging operation with the battery-driven device 100 being placed on in the charging base 110 with reference to FIGS. 4 and 5. In FIG. 4, the charging base 110, and the battery-driven device 100 are shown in the right and left parts, respectively, in charging operation on the battery pack 90 that is accommodated in the battery-driven device 100. In FIG. 5, the charging base 110 is shown in the right part in charging operation on the battery pack 90. When the charging base 110 charges the battery pack 90 in the non-contact charging manner, high frequency electric power is supplied from the high frequency power supply control circuit 114 to the energizing coil 113 so that a magnetic flux is produced. Correspondingly, induced electric power can be produced in the energized coil 1 in the battery pack 90. The high frequency power supply control circuit 114 in the charging base 110 can be supplied with DC power through the DC input terminals 117, which include the DC connection terminal 117A and the USB terminal 117B. Specifically, DC power from the charging base side AC/DC converter is supplied the DC connection receptacle 117A. The charging-base-side rechargeable battery 112 of the charging base 110 can be charged with this DC power. Also, this DC electric power can be supplied to the high frequency power supply control circuit 114. After that, the DC electric power can be converted into high frequency electric power, and supplied to the energizing coil 113. In the case where the charging-base-side rechargeable battery 112 in the charging base 110 has been charged, if DC power is not supplied to the DC input terminal 117, this charging-base-side rechargeable battery 112 can supply DC power to the high frequency power supply control circuit 114. According to this construction, the energizing coil 113 for the non-contact electric power transmission can be electromagnetically connected to the energized coil 1 in the energized device through the magnetic flux so that induced electric power can be supplied to the energized coil 1.

A DC power control circuit 121 controls the electric power supplying operation on the high frequency power supply control circuit 114. DC power can be switched between the DC input terminals 117 and the charging-base-side rechargeable battery 112 by ON/OFF operation of switches SW1, SW2, SW3, and SW4. In the case where the charging-base-side rechargeable battery 112 is charged, the DC electric power control circuit 121 recognizes that DC power is supplied through the DC input terminal 117, and turns the switch SW1 or SW2, and the switch SW3 ON so that a current can flow into the charging-base-side rechargeable battery 112. When the DC electric power can be supplied to the charging-base-side rechargeable battery 112, an internal charging circuit 118 determines whether the charging-base-side rechargeable battery 112 is fully charged. If the charging-base-side rechargeable battery 112 can be charged, the internal charging circuit 118 charges the charging-base-side rechargeable battery 112. If the charging-base-side rechargeable battery 112 is fully charged, the internal charging circuit 118 does not supply the electric power to the charging-base-side rechargeable battery 112. According to this construction, the charging base 110 can a mobile charger. In addition, even in the case where neither AC power nor USB power can be supplied to the charging base 110, electric power can be supplied to the high frequency power supply control circuit 114 from the charging-base-side rechargeable battery 112 so that the battery pack 90 can be charged in the non-contact charging manner.

The high frequency power supply control circuit 114 determines whether the energized coil 1 to be electromagnetically connected to the energizing coil 113 is located within a detectable area or not. If the energized coil 1 is located within the detectable area, the high frequency power supply control circuit 114 will supply electric power to the energized coil 1. If the energized coil 1 is located out of the detectable area, the high frequency power supply control circuit 114 does not supply electric power to the energized coil 1. According to this construction, the charging base 110 can transmit electric power only when necessary without wasting energy for power transmission. As a result, energy can be saved.

The DC electric power control circuit 121 is connected to a charge-status-indicating LED 119 that can flash in different flashing patterns. The DC electric power control circuit 121 can detect voltage change, current, phase change and/or modulation frequency of the high frequency wave of the high frequency power supply control circuit 114, and can receive the remaining capacity, charging voltage information, full charge status information, in-abnormality output stop signal, and the like based on the detection. Accordingly, the LED 119 can indicate the charge status by using the flashing patterns. According to this construction, the charging base 110 can stop supplying high frequency power based on the full charge status information whereby transmitting electric power only when necessary. As a result, energy can be saved.

### (Operation of Battery Pack 90)

The following description describes operation of the battery pack 90 with reference to FIGS. 4 to 6. The battery-driven device 100 according to this embodiment shown in FIG. 4 includes the battery pack 90, and a battery-driven device main unit 101 that is supplied with electric power from this battery pack 90. The battery pack 90 includes the connection terminals. The connection terminals are a pair of power supply terminals 102 and 104, and the temperature terminal 103. According to this construction, when the battery pack 90 is connected to the battery-driven device main unit 101 through the three terminals, the battery pack 90 and the battery-driven device main unit 101 can transmit/receive the control information on the battery-driven device 100 of the battery-driven device main unit 101, the battery information on the rechargeable battery cell 2 of the battery pack 90, and the like, to/from each other.

High frequency electric power as induced electric power can be produced in the energized coil 1 in the battery pack 90 by the magnetic flux from the energizing coil 113. The High frequency electric power can be converted into DC power by the non-contact charging circuit 95 so that the rechargeable battery cell 2 can be charged with the DC power, which is supplied through the terminal-switching portion 93. In the non-contact charging circuit 95 according to this embodiment, although not illustrated, high frequency electric power is rectified by a rectifying circuit, and only the DC component of the rectified power is provided as DC power by a smoothing capacitor. Accordingly, the rechargeable battery cell 2 can be charged with the DC power.

The battery pack 90 according to this embodiment includes a charging switch 98 and the terminal-switching portion 93. Open/close operation of the charging switch 98 and terminal-switching portion 93 are controlled by the pack-controlling portion 91. The electric power output of the non-contact charging circuit 95 is controlled through the charging switch 98 so that the supply of electric power for charging the rechargeable battery cell 2 can be controlled. Specifically, when the battery pack is placed onto the charging base 110, the charging switch 98 is in the opened state. If electric power is supplied to the battery pack in the non-contact charging manner, the pack control circuit 91 will be activated so that the charging switch 98 will be brought in the closed state. The opened/closed states of the terminal-switching portion 93 are controlled based on whether the battery pack is connected to the battery-driven device 100 or not. The default state of this terminal-switching portion 93 is the opened state.

In the case where the charging switch 98 and the terminal-switching portion 93 are constructed of semiconductor devices such as FETs and the transistors capable of controlling a current flow, the circuit can be small. It is preferable that the charging switch and the terminal-switching portion be constructed of semiconductor devices of FETs. The power loss of FETs is small when a current flows through the FETs. As a result, it is possible to reduce the conversion loss of the energized electric power. In this case, as shown in FIG. 4, the pack-controlling portion 91 can include a terminal-switching control line SWL through which the ON/OFF signal is provided to the gate terminal of the FET. According to this construction, the pack-controlling portion can switch between HIGH and LOW whereby controlling ON/OFF of the FET.

Also, the terminal-switching portion 93 can be constructed of a plurality of switching elements. For example, in the case where the terminal-switching portion 93 is constructed of first and second switching elements, the first switching element can be connected to the temperature-detecting portion 94, while the second switching element can be connected to the control terminal of the first switching element. In this case, ON/OFF of the first switching element can be controlled based on ON/OFF of the second switching element. Also, when the second switching element is brought OFF, the voltage from the AC/DC adapter can be applied to the control terminal of the first switching element so that the first switching element can be turned ON.

As shown in FIG. 4, it is preferable that the FETs of the terminal-switching portion 93 be first and second FETs 93a and 93b. The first FET 93a has the gate terminal, which is connected to the terminal-switching control line SWL. The second FET 93b has the gate terminal, which is connected to the drain terminal of the first FET 93a. The source terminals of the first and second FETs 93a and 93b are connected to a common line.

This pack-controlling portion 91 determines whether the charging operation on the battery pack 90 is the non-contact charging operation of the charging base 110 or not. Corresponding to this determination, an MPU as the pack-controlling portion 91 can be activated by the electric power of non-contact charging operation, and can switch ON/OFF of the terminal-switching portion 93 through the terminal-switching control line SWL. Specifically, when the battery pack is charged in the non-contact charging manner, the terminal-switching control line SWL is turned to HIGH. Accordingly, as shown in FIG. 4, in FETs of the terminal-switching portion 93, the first FET 93a is turned ON so that a current can flow through the first FET 93a, while the second FET 93b is turned OFF so that the temperature-detecting portion 94 is disconnected. As a result, the battery pack can communicate with the battery-driven device 100 through the temperature terminal 103.

On the other hand, when the battery pack is charged by the AC/DC adapter, as shown in FIG. 6, the pack-controlling portion 91 turns the terminal-switching control line SWL to LOW. Accordingly, the first FET 93a is turned OFF so that a certain voltage is applied to the gate terminal of the second FET 93b, which turns this second FET 93b ON. As a result, a current can flows through the temperature-detecting portion 94. According to this construction, the pack-controlling portion 91 can easily switch between the functions of the temperature terminal 103 with HIGH/LOW of the terminal-switching control line SWL.

In the battery pack 90 shown in FIG. 4, the pack control circuit 91, which controls the electric power output of the synchronous rectifier circuit 95, gives an instruction for closing the charging-power-supplying switch 98 (charge-starting instruction). This instruction can be given based information about the temperature and the supply of DC power. When the temperature that is detected by the thermistor (not shown) included in the pack-controlling portion 91 falls within a predetermined range, and when DC power is not supplied from the battery-driven device 100 (discussed later), the charging-power-supplying switch 98 is closed so that charging operation starts. The pack control circuit 91 receives the information, and controls the charging-power-supplying switch 98. According to this construction, the rechargeable battery cell 2 can be protected from the temperature rise when the battery pack 90 is charged.

### (Pack-Controlling Portion 91)

The pack-controlling portion 91 is connected to the temperature terminal 103. When the battery pack communicates with the charging base 110 in the non-contact charging operation, the pack-controlling portion 91 turns the terminal-switching portion 93 OFF so that the battery pack can communicate with the battery-driven device 100 through the temperature terminal 103. According to this construction, the temperature terminal 103 can serve as a communication terminal through which the battery pack can communicate with the battery-driven device 100 when the battery pack is charged in a non-contact charging manner. Thus, one terminal can serve as both the temperature terminal 103 and the communication terminal. As a result, it is possible to suppress the increase of the battery pack in cost. In addition, it is possible to avoid that the space is limited by the increased number of components. For example, UART, or the like can be used for communication.

In the pack-controlling portion 91, as shown in FIG. 4, a transmission FET 97a is connected to a reception FET 97b. In addition, the pack-controlling portion 91 is provided with the thermistor as cell temperature-detecting portion, which detects a temperature in the battery pack 90.

### (Device-Connection Determining Portion)

A device-connection determining portion determines whether the battery pack 90 is connected to the battery-driven device 100 or disconnected from the battery-driven device 100. The device-connection determining portion can be realized by the pack-controlling portion 91, for example. In the battery pack according to this embodiment shown in FIG. 4, the function of the device-connection determining portion is realized by an IC as the MPU corresponding to the pack-controlling portion 91. However, the device-connection determining portion may be separately provided from the pack-controlling portion. In the battery pack 90 according to this embodiment, the pack-controlling portion 91 can determine whether the battery pack 90 is connected to the battery-driven device main unit 101 based on whether the battery pack 90 can communicate with the battery-driven device main unit 101.

The pack-controlling portion outputs HIGH on the terminal-switching control line SWL so that the terminal-switching portion 93 is turned OFF. Accordingly, the temperature-detecting portion 94 can be disconnected from GND.

In the determination of the device-connection determining portion, when the pack-controlling portion 91 tries communicating with the battery-driven device 100, it can be determined whether the battery pack is connected to the battery-driven device 100 or not based on whether the pack-controlling portion 91 successfully communicates with the battery-driven device 100 or not. For example, if the battery pack successfully communicates with the battery-driven device 100 through the temperature terminal 103, it can be determined that the battery pack is connected to the battery-driven device 100. Conversely, if the battery pack cannot communicate with the battery-driven device 100 through the temperature terminal 103, it can be determined that the battery pack is disconnected (solely provided) from the battery-driven device 100. The charge conditions of the non-contact charging operation can be changed based on the determination result. For example, it is conceivable that the distance between the energized coil and the energizing coil will be different in the case where the battery pack is connected to the battery-driven device 100 from the case where the battery pack is disconnected from the battery-driven device 100. That is, in the case where the battery pack 90 is connected to the battery-driven device 100, the battery pack 90 is accommodated in the exterior case of the battery-driven device 100. For this reason, the distance between the energized coil and the energizing coil is increased by the thickness of the exterior case. On the other hand, in the case where the battery pack 90 is solely placed on the charging base, it is not necessary to take this thickness of the exterior case into consideration. The energized coil and the energizing coil are electromagnetically connected to each other at a short distance. As discussed above, the pack-controlling portion 91 changes the conditions of non-contact charging operation based on the determination result of the device-connection determining portion. As a result, the battery pack can be charged in proper conditions in the non-contact charging manner.

The following description describes the charging operation in the connection shown in FIG. 4. When the battery pack 90 is connected to the driven-device main unit 101, the battery pack 90 can communicate with the driven-device main unit 101 through the temperature terminal 103. In the UART communication, the driven device main unit 101 serves as the master, while the battery pack 90 serves as the slave. A device-side control portion 150 on the master side can query the pack-controlling portion 91 on the slave side at time series or periodically to transmit information such as a temperature in the battery pack 90, a rechargeable battery cell voltage, and a current value (measured by a non-contact current detection resistor 99). The pack-controlling portion 91 will detect communication from the device-side control portion 150, and can determine that the battery pack 90 is connected to the driven-device main unit 101. After that, the pack-controlling portion 91 turns the charging switch 980N, and starts charging the rechargeable battery cell in the non-contact charging manner. The pack-controlling portion 91 can communicate with the driven-device main unit by using the aforementioned transmission and reception FETs 97a and 97b.

The following description describes the non-contact charging operation on the battery pack 90 that is solely placed in the charging base with reference to FIG. 5. When the battery pack 90 is placed onto the charging base 110, the charging switch 98 is opened. If electric power is supplied to the battery pack in the non-contact charging manner, the pack control circuit 91 will be activated so that the charging switch 98 will be closed. When the pack-controlling portion 91 is activated, the pack-controlling portion 91 will outputs HIGH on the terminal-switching control line SWL so that the terminal-switching portion 93 is turned OFF. After that, the pack control circuit 91 will determine disconnection through the temperature terminal 103 of the battery pack from the driven-device main unit, and then turn the charging switch 980N so that the rechargeable battery cell 2 can be charged. A temperature in the battery pack 90 can be detected by the cell temperature-detecting portion (not shown) included in the pack control circuit 91. Also, a charging current is detected by the non-contact current detection resistor 99. The pack-controlling portion 91 can superimpose the signal on transmission electric power and transmit the signal to the charging base 110. The rechargeable battery cell 2 can be charged in a constant-current/constant-voltage charging manner where the maximum current and the maximum voltage are restricted. If detecting that the charging current becomes lower than a predetermined current value when a charging voltage higher than a predetermined voltage is applied to the rechargeable battery cell, the pack-controlling portion 91 can determine that the rechargeable battery cell is fully charged. After that, the pack-controlling portion 91 will transmit a charge stop signal to the charging base 110 whereby stopping the non-contact charging operation on the battery pack 90. In addition, the pack-controlling portion 91 will turn the charging switch 98 OFF.

In addition, the default state of the terminal-switching portion 93 is the opened state. Accordingly, in the case where the battery pack 90 is solely stored, any discharging circuit cannot be formed. As a result, it is possible to minimize self-discharge of the battery pack 90.

### (Charging Operation of Adapter)

The following description describes the charging operation with the battery-driven device 100 being connected to the AC/DC adaptor 143 with reference to FIG. 6. The charging base 110 is not shown in FIG. 6. The battery pack 90 is connected to the drive device main unit 101, and is charged. In FIG. 6, the battery-driven device 100 shown in the right part is connected to the AC/DC adaptor 143 in charging operation on the battery pack 90 that is accommodated in the battery-driven device 100. In the charging operation on the battery pack 90 shown in FIG. 6, the DC connection plug 141 of the connected AC/DC adapter 143 that is connected to the commercial power is connected to the DC connection receptacle 117A of the battery-driven device main unit 101 so that DC electric power can be supplied to the battery-driven device main unit 101. When DC electric power is supplied to the battery-driven device main unit 101, the DC electric power is supplied to the adapter-charging circuit 159 through the DC connection receptacle 117A. The adapter-charging circuit charges the battery pack in the constant-current/constant-voltage charging manner where the maximum current and the maximum voltage are restricted. As shown in FIG. 6, in the charging operation of the AC/DC adapter, the device-side control portion 150 of the battery-driven device 100 detects the connection of the AC/DC adapter 143, and stops applying a current to a pull-up resistor 158 whereby stopping communication of the battery-driven device main unit with the battery pack.

On the other hand, in the case where non-contact charging electric power is not supplied, the pack-controlling portion 91 in the battery pack 90 is shut down so that the terminal-switching control line SWL is in the LOW state. Accordingly, the voltage is applied to the gate terminal of the second FET 93b of the terminal-switching portion 93 so that the second FET 93b is ON. Thus, the temperature-detecting portion 94 can be electrically connected to the lower line shown in FIG. 6. When a voltage is applied from the battery-driven device main unit 101 to the temperature-detecting portion 94, the device-side control portion 150 can detect a temperature (in particular, a temperature in the charging operation) by using the temperature-detecting portion 94. Thus, the battery pack can be charged by the AC/DC adapter 143.

### (Charging-Method Determining Function)

The battery pack 90 has a charging-method determining function for determining whether this battery pack is charged by the AC/DC adapter 143 or by the charging base 110 (non-contact charging method). Specifically, the battery pack can determine the charging method based on the information in the communication between this battery pack and the battery-driven device main unit 101.

### (Adapter Detecting Portion)

When the charging method is determined, it is necessary to determine whether the AC/DC adapter 143 is connected to the battery-driven device. To address this, the battery pack 90 can have an adapter detecting portion for determining whether the battery pack 90 is connected to the battery-driven device 100 that is supplied with electric power by the AC/DC adapter 143 from the external commercial power. For example, the adapter detecting portion can be realized by the pack-controlling portion 91 in the exemplary circuit shown in FIG. 4, etc. The pack-controlling portion 91 can determine whether the AC/DC adapter 143 is connected to the battery-driven device 100 or not based on the voltage from the AC/DC adapter 143. In the exemplary circuit of FIG. 6 showing the AC/DC adapter 143 that is connected to the battery-driven device 100 shown in FIG. 4, the pack-controlling portion 91 can receive the voltage of DC power supply of the AC/DC adapter 143, or a conversion voltage that is converted by the adapter-charging circuit 159, which is applied to the temperature terminal 103 of the battery pack 90. If a voltage on the temperature terminal 103 is not smaller a predetermined voltage, the pack-controlling portion 91 determines that the AC/DC adapter 143 is connected to the battery-driven device. Also, the battery pack can receive connection information on the adapter through the temperature terminal 103 from the battery-driven device 100, and determine whether the AC/DC adapter 143 is connected to the battery-driven device or not based on the received connection information. Although exemplary features are illustratively described, needless to say, the adapter detecting portion may be separately provided from the pack-controlling portion.

When determining that the AC/DC adapter 143 is connected to the battery-driven device, the pack-controlling portion 91 switches the charging method from the non-contact charging method to the charging method of the adapter. As discussed above, when determining that the AC/DC adapter is connected to the battery-driven device, the pack-controlling portion 91 turns the charging switch 98 into the opened state whereby stopping the non-contact charging operation.

When the battery pack is charged by the adapter, the terminal-switching portion 93 is closed so that the rechargeable battery cell temperature can be provided to the battery-driven device 100 through the temperature terminal 103. According to this construction, the temperature terminal 103 can serve as the temperature terminal through the rechargeable battery cell temperature can be provided when the battery pack is charged by the AC/DC adapter.

If charging operation of the AC/DC adapter 143 conflicts with the non-contact charging operation of the charging base 110, the pack-controlling portion 91 can inform the battery-driven device 100 that the non-contact charging operation stops, and requests the battery-driven device 100 to charge the battery pack 90 by using the AC/DC adapter 143 based on the communication through the temperature terminal 103. In this embodiment, the battery pack 90 sends the signal for stopping the non-contact charging operation to the charging base 110 so that the charging base 110 stops supplying electric power. Subsequently, the charging operation of the AC/DC adapter 143 will start. According to this construction, if the charging operation of the adapter conflicts with the non-contact charging operation of the charging base, the non-contact charging operation stops so that the charging operation of the AC/DC adapter has higher priority than the non-contact charging operation of the charging base. As a result, the battery pack can be stably charged with a reduced energy loss.

(Conflict between Adapter Charging Operation and Non-Contact Charging Operation)

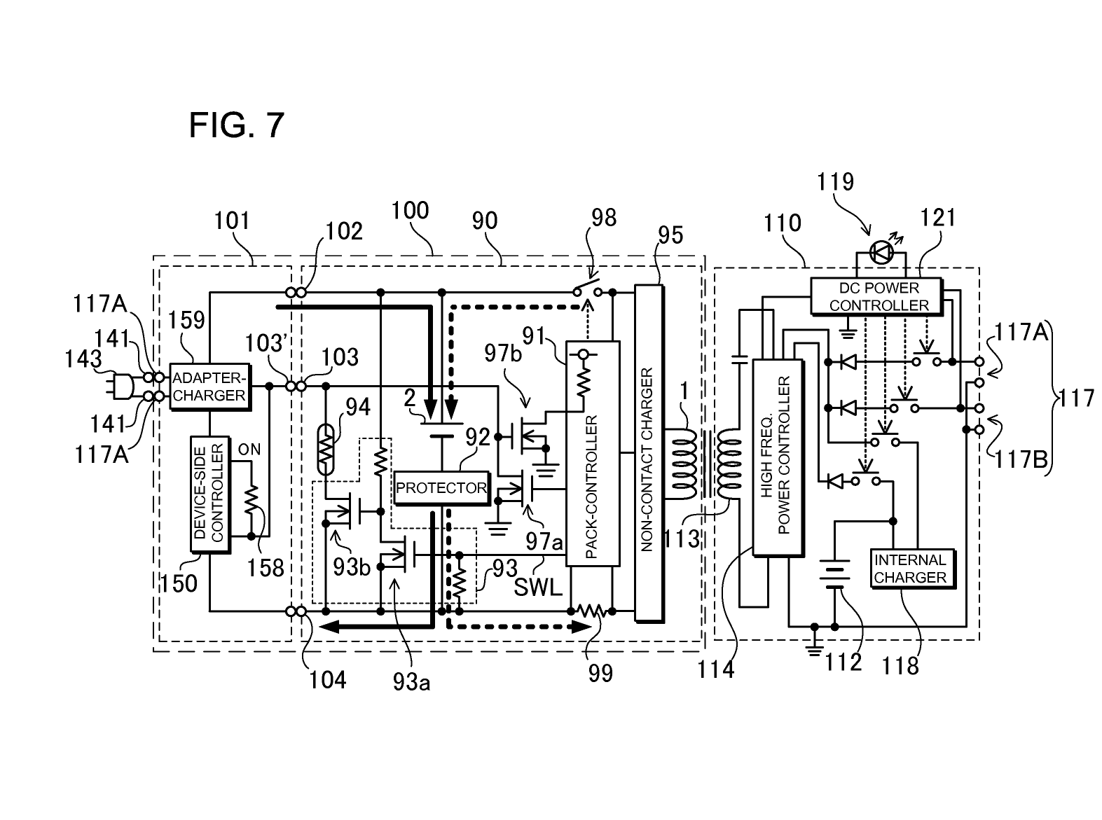

The following description describes charging operation where the charging operation of the adapter has higher priority than the non-contact charging operation when the charging operation of the adapter conflicts with the non-contact charging operation with reference to FIG. 7. In the case where the battery pack 90 is being placed onto the charging base 110, before the battery pack 90 is placed onto the charging base 110, the charging switch 98 is opened. When electric power is supplied from the charging base 110 to the battery pack in the non-contact charging manner, the pack control circuit 91 will be activated so that the charging switch 98 will be closed. When activated, the pack-controlling portion 91 outputs HIGH on the terminal-switching control line SWL so that the terminal-switching portion 93 is turned OFF. In this state, the rechargeable battery cell 2 can be charged.

In the case where the terminal-switching portion 93 is OFF, the temperature-detecting portion 94 is opened. Accordingly, the device-side control portion 150 cannot detect a voltage on the upper line shown in FIG. 7. In this case, the adapter-charging circuit 159 can stop charging operation of the AC/DC adapter 143. Subsequently, the device-side control portion 150 will apply a current to the pull-up resistor 158. After that, the device-side control portion 150 will communicate with the pack control circuit 91 of the battery pack 90 through the temperature terminal 103, and give an instruction for stopping the non-contact charging operation. Correspondingly, the pack control circuit 91 sends the signal for stopping the non-contact charging operation to the charging base 110 so that the non-contact charging operation can stop. The charging switch 98 is then turned OFF. Also, the terminal-switching control line SWL can be turned to LOW based on the output or shutdown of the pack control circuit 91.

Although the terminal-switching control line SWL is turned to LOW, a voltage is applied to the gate terminal of the second FET 93b of the terminal-switching portion 93 through a resistor R so that the second FET 93b will be brought ON. Accordingly, the temperature-detecting portion 94 can be electrically connected to the lower line shown in FIG. 7. The device-side control portion 150 will stop applying a current to the pull-up resistor 158 so that the temperature can be detected by the temperature-detecting portion 94. In this state, the charging operation of the adapter starts. Consequently, the charging operation of the adapter has higher priority than the non-contact charging operation. If determining that the battery pack is fully charged, the adapter-charging circuit 159 stops the charging operation.

In addition, it can be conceived that the battery-driven device 100 with the battery pack 90 is placed on the charging base 110 with the battery-driven device 100 being connected the AC/DC adapter 143 in the charging operation of the AC/DC adapter 143, as shown in FIG. 7. In this case, it is necessary to stop the charging operation of the AC/DC adapter or the non-contact charging operation. To address this, the charging operation is properly controlled so that the non-contact charging operation stops while the charging operation of the adapter is executed. The following three cases can be conceived where charging modes conflict to each other. In all the three cases, the charging operation is controlled so that the non-contact charging operation stops while the charging operation of the AC/DC adapter 143 is only executed.

(1) In the where the battery-driven device with the battery pack is placed on the charging base 110 with the battery-driven device being connected the AC/DC adapter 143 in the charging operation of the AC/DC adapter 143.

In this case, the pack-controlling portion 91 is once activated. However, since a voltage on a state-communication line is low, the pack-controlling portion 91 will send the stop signal to the charging base 110 so that the non-contact charging operation on the battery pack 90 is disabled.

(2) In the where the battery-driven device with the battery pack is brought into electrical connection with the AC/DC adapter 143 during the non-contact charging operation.

In this case, according to the priority, the charging operation of the adapter is executed as discussed in the case of FIG. 7.

(3) In the where the battery pack connected to the battery-driven device is simultaneously charged by the non-contact charging operation and the charging operation of the AC/DC adapter 143.

This case will correspond to any of the aforementioned cases (1) and (2). As a result, according to the priority, the charging operation of the adapter is executed.

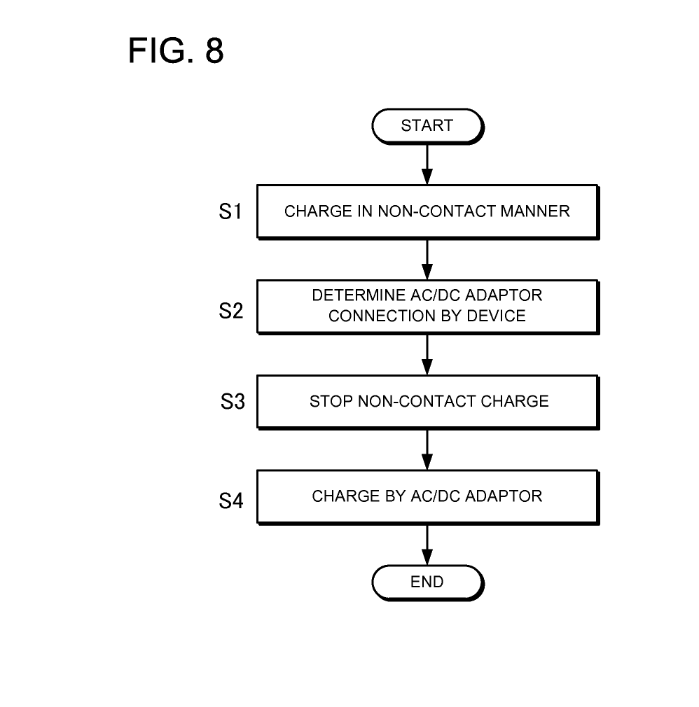

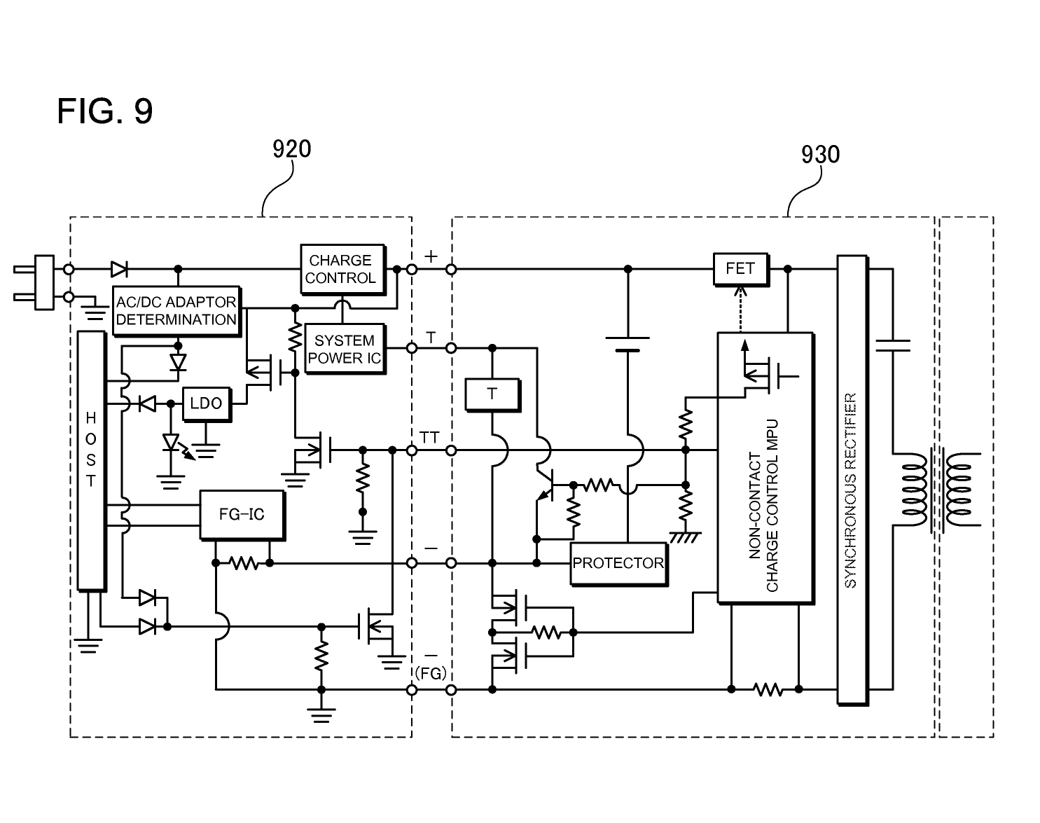

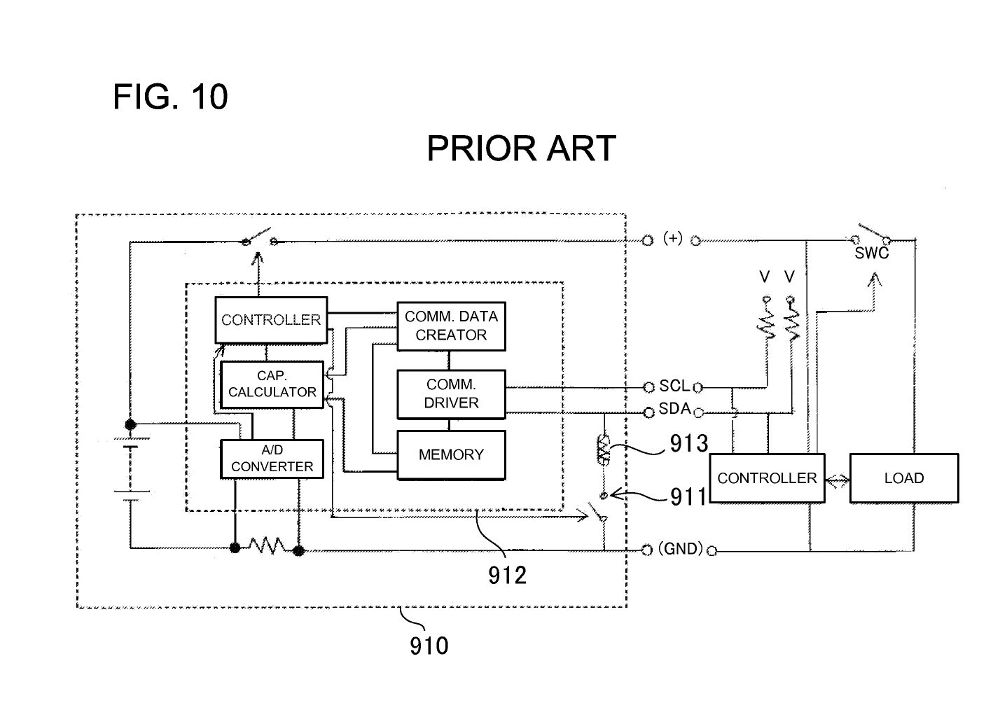

The following description describes the charging method selection procedure with reference to a flowchart of FIG. 8. Here, it is described the case where the charging method is switched from the non-contact charging operation that has been executed to the charging operation of the adapter. The battery pack is charged in the non-contact charging manner in Step S1. At this time, the temperature-detecting portion 94 is disconnected. The charging operation of the AC/DC adapter 143 is not executed. After that, the battery-driven device 100 detects connection of the AC/DC adapter 143 in Step S2. In this case, after detecting connection of the AC/DC adapter 143, the device-side control portion 150 sends the charge stop signal to the pack-controlling portion 91 in the communication between the battery pack and the battery-driven device. In response to this signal, the battery pack 90 stops charging the rechargeable battery cell in the non-contact charging manner in Step S3. Subsequently, the charging operation of the AC/DC adapter 143 starts in Step S4.

### (Temperature-Detecting Portion 94)

Although the temperature-detecting portion 94 is spaced away from the rechargeable battery cell 2 in FIG. 4 for ease of illustration, practically the temperature-detecting portion 94 is arranged in proximity to the rechargeable battery cell 2. For example, the temperature-detecting portion can detect a temperature on the rechargeable battery cell 2 with the temperature-detecting portion being in contact with the surface of the rechargeable battery cell 2. A PTC thermistor, NTC thermistor, or the like can be suitably used as the temperature-detecting portion 94.

As discussed above, the battery pack 90 can determine whether the rechargeable battery cell 2 is charged by the battery-driven device main unit 101 or with induced electric power from the non-contact charging base 110 based on the device connection state.

### (Protection Circuit 92)

In addition, the battery pack can include a protection circuit 92 that can protect the rechargeable battery cell 2 from an over-charging current. In the battery pack shown in FIG. 4, the protection circuit 92 is serially connected to the rechargeable battery cell 2. If a charging current higher than the predetermined threshold flows through the protection circuit 92, the protection circuit 92 can cut off the current so that the rechargeable battery cell 2 can be protected. The protection circuit 92 is not limited to detect an over-charging current. The protection circuit 92 can be opened whereby cutting off a current if any abnormality is detected in voltage or temperature of the rechargeable battery cell or if it is detected that the rechargeable battery cell is over-charged.

### (Construction of Battery-Driven Device 100)

The following description describes the construction of the battery pack 100 with reference to FIGS. 4 to 6. The illustrated battery-driven device 100 includes the adapter-charging circuit 159, the device-side control portion 150, the DC connection receptacle 117A, and the pull-up resistor 158. The adapter-charging circuit 159 is connected to the AC/DC adapter 143, and supplied with electric power from this AC/DC adapter 143. The adapter-charging circuit 159 converts the supplied electric power into suitable electric power for charging the battery pack 90. The device-side control portion 150 controls operation of the adapter-charging circuit 159. The device-side connection terminals are electrically connected to the device-side control portion 150. The device-side connection terminals can be connected to the connection terminals of the battery pack 90. The DC connection receptacles 117A can be connected to the AC/DC adapter 143. The device-side connection terminals include the device-side temperature terminal 103′, and a pair of device-side output terminals.

### (Temperature Terminal 103)

As discussed above, when the terminal-switching portion 93 is disconnected the temperature-detecting portion 94 from the temperature terminal 103, the temperature terminal 103 can serve as the communication terminal.

When the battery pack is charged by the charging base 110 in the non-contact charging manner, the battery-driven device 100 can detect through the device-side temperature terminal 103′, which is included in the battery-driven device 100 and is connected to the temperature terminal 103 of the battery pack, that the pack-controlling portion 91 turns the terminal-switching portion 93 OFF so that the battery pack can communicate with the battery-driven device 100. According to this construction, when the battery pack 90 is charged in the non-contact charging manner, the battery pack 90 can inform the battery-driven device 100 that the charging mode is switched to the non-contact charging mode. After that, the battery pack 90 and the battery-driven device 100 can communicate with each other.

### INDUSTRIAL APPLICABILITY

A battery pack according to the present invention can be suitably used as battery packs for mobile phone, portable music player, PDA, and the like.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2011-166,094 filed in Japan on Jul. 28, 2011, the content of which is incorporated herein by reference.

What is claimed is:

1. A battery pack that can be connected to a battery-driven device and supply the battery-driven device with electric power for driving the battery-driven device, and can be placed on a charging base and supplied with electric power from an energizing coil included in the charging base for charging the battery pack in a non-contact charging manner, the battery pack comprising:
a rechargeable battery cell;
an energized coil that can be electromagnetically connected to the energizing coil included in the charging base;
a temperature-detecting portion that detects the temperature of said rechargeable battery cell;
a terminal-switching portion that is connected to said temperature-detecting portion in series;
a pack-controlling portion that controls ON/OFF of said terminal-switching portion; and
connection terminals that allow the battery pack to be electrically connected to the battery-driven device,
wherein said connection terminals includes
a pair of power supply terminals through which said rechargeable battery cell can be charged/discharged, and
a temperature terminal that is connected to said temperature-detecting portion,
wherein said pack-controlling portion is connected to said temperature terminal, and
wherein when the battery pack is charged by the charging base in the non-contact charging manner, said terminal-switching portion is turned OFF so that the battery pack can communicate with the battery-driven device through said temperature terminal.

2. The battery pack according to claim 1,
wherein said battery pack can be charged by an AC/DC adapter with said battery pack being connected to the battery-driven device,
wherein said pack-controlling portion turns said terminal-switching portion ON when said battery pack is charged by the AC/DC adapter so that information about the temperature of said rechargeable battery cell can be provided to the battery-driven device.

3. The battery pack according to claim 2,
wherein said terminal-switching portion includes an FET,
wherein said pack-controlling portion includes a terminal-switching control line through which the ON/OFF signal is provided to the gate terminal of said FET, and
wherein said pack-controlling portion turns the terminal switching control line to HIGH when the battery pack is charged in the non-contact charging manner, and turns the terminal switching control line to LOW when said battery pack is charged by the AC/DC adapter, so that said temperature-detecting portion can be connected/disconnected to/from said temperature terminal.

4. The battery pack according to claim 3,
wherein said temperature-detecting portion is connected to a first switching element,
wherein the control terminal of said first switching element is connected to a second switching element,
wherein ON/OFF of said first switching element is controlled based on ON/OFF of said second switching element, and
wherein when said second switching element is brought OFF, the voltage from the AC/DC adapter is applied to the control terminal of said first switching element so that said first switching element can be turned ON.

5. The battery pack according to claim 4,
wherein FETs are provided as said FET of the terminal-switching portion,
wherein the FETs include
a first FET that has the gate terminal, which is connected to said terminal-switching control line, and
a second FET that has the gate terminal, which is connected to the drain terminal of said first FET,
wherein the source terminals of said first and second FETs are connected to a common line, and
wherein when said battery pack is charged by the AC/DC adapter, said pack-controlling portion turns said terminal-switching control line to LOW so that said first FET is turned OFF, and applies the voltage from the AC/DC adapter to the gate terminal of said second FET and turns the second FET ON so that current can flow through said temperature-detecting portion.

6. The battery pack according to claim 2, wherein when the battery pack is charged by the charging base in the non-contact charging manner, the battery-driven device can determine through a device-side temperature terminal, which is included in the battery-driven device and is connected to said temperature terminal of the battery pack, that said pack-controlling portion turns said terminal-switching portion OFF so that the battery pack can communicate with the battery-driven device.

7. The battery pack according to claim 6, wherein when the battery pack is charged by the charging base in the non-contact charging manner, the device-side temperature terminal, which is included in the battery-driven device and is connected to said temperature terminal of the battery pack, is connected to a pull-up resistor so that said pack-controlling portion can communicate with a device-side control portion.

8. The battery pack according to claim 2, wherein if charging operation of the AC/DC adapter conflicts with the non-contact charging operation of the charging base, said pack-controlling portion can inform the battery-driven device that the non-contact charging operation stops, and requests the battery-driven device to charge the battery pack by using the AC/DC adapter based on the communication through said temperature terminal.

9. The battery pack according to claim 1, wherein said temperature-detecting portion is a thermistor that is arranged in proximity to said rechargeable battery cell.

10. The battery pack according to claim 1, wherein said energized coil has a rectangular exterior shape.

11. The battery pack according to claim 1 further comprising a device-connection determining portion that determines whether the battery pack is connected to the battery-driven device or not.

12. The battery pack according to claim 11, wherein when said pack-controlling portion tries communicating with the battery-driven device, said device-connection determining portion determines whether the battery pack is connected to the battery-driven device or not based on whether said pack-controlling portion successfully communicates with the battery-driven device or not.

13. The battery pack according to claim 1, wherein said pack-controlling portion determines that the battery pack is disconnected from the battery-driven device if said pack-controlling portion cannot communicate with the battery-driven device through said temperature terminal, wherein if said pack-controlling portion determines that the battery pack is disconnected from the battery-driven device, said pack-controlling portion controls charging operation on the battery pack in the non-contact charging manner according to the specifications of the battery pack.

14. The battery pack according to claim 1, wherein said pack-controlling portion determines that the battery pack is connected to the battery-driven device if said pack-controlling portion successfully communicates with the battery-driven device through said temperature terminal, wherein if said pack-controlling portion determines that the battery pack is connected to the battery-driven device, said pack-controlling portion controls charging operation on the battery pack according to the connection conditions of the battery pack to the battery-driven device.
